(19) United States
(12) Patent Application Publication
(10) Pub. No.: US 2010/0063933 A1
(43) Pub. Date: Mar. 11, 2010

(54) METHOD OF OPTIMIZING THE AVAILABILITY OF AN AIRCRAFT OR OF A FLEET OF AIRCRAFT

(75) Inventors: Radhouane DJERIDI, MARSEILLE (FR); Mathieu GLADE, SANARY SUR MER (FR)

Correspondence Address: YOUNG & THOMPSON, 209 Madison Street, Suite 500, Alexandria, VA, 22314, US

(73) Assignee: EUROCOPTER, MARIGNANE Cedex (FR)

(21) Appl. No.: 12/555,345

(22) Filed: Sep. 8, 2009

(30) Foreign Application Priority Data
Sep. 9, 2008 (FR) 08 04932

(51) Int. Cl. G06Q 10/00; G06Q 50/00

(52) U.S. Cl. 705/301

(57) ABSTRACT

The present invention provides a method of optimizing the operational availability of at least one aircraft or of a fleet of aircraft as a function of constraints associated with maintenance and with the use of said aircraft, the method consisting in:
using a forecast maintenance plan for the aircraft;
adapting the forecast maintenance plan in real time as a function of maintenance operations carried out and/or as a function of unexpected maintenance operations that result from malfunctions diagnosed in one or more of the pieces of equipment of the aircraft; and
adapting the forecast maintenance plan continuously as a function of the actual use of the aircraft so as to provide the manufacturer, the operator, and the maintenance services with a maintenance plan that is forecast and dynamic.

### FIELD OF THE INVENTION

The present invention relates to the general technical field of maintaining and overhauling aircraft, and more particularly to planning such maintenance and overhaul operations.

The present invention thus relates to optimizing the use of an aircraft or a fleet of aircraft, e.g. helicopters, that require maintenance or repair operations to be performed thereon that affect the availability of the aircraft or the fleet of aircraft.

### STATE OF THE ART

At present, aircraft manufacturers deliver aircraft with a recommended maintenance program, referred to also as PRE or maintenance plan, that is predetermined as a function of the model of the aircraft. The program contains all of the deadlines to be complied with in the maintenance of the aircraft. The operator of the aircraft is generally the only body responsible for complying with those deadlines, for the planning, for the organization, and for the logistics of maintenance operations. The same applies for the means needed to enable maintenance operations to be performed.

The clients of aircraft manufacturers thus desire to benefit from maximum availability of the aircraft in their fleet so as to reduce operating costs and maximize their profits that depend on using the aircraft.

Unfortunately, availability indicators do not make it possible to provide fine modeling for a fleet of aircraft.

In addition, the lack of similarity between the operating needs of two different fleets belonging to different operators, with different operating needs, prevents the manufacturer from proposing a standard recommended maintenance program that is appropriate for all fleets.

Furthermore, the data used at present for determining availability is too approximate or arbitrary and consequently limits the possibility of achieving a standard maintenance program that is adapted to all operators.

Furthermore, insufficient capitalization of the data relating to availability means that it is not possible to improve the operation of a fleet on a continuous basis and also means that it is not possible to improve reactivity in the management of maintenance.

### OBJECT AND SUMMARY OF THE INVENTION

Consequently, the present invention seeks to propose a method of optimizing the operational availability of aircraft that enables the above-mentioned limitations to be avoided and that is based on a dynamic maintenance infrastructure that varies as a function of the history of use of the aircraft.

The present invention also seeks to improve the reactivity of the logistics support for aircraft by planning periods of unavailability because of maintenance to coincide with periods when the aircraft are not required.

The present invention also seeks to enable the operator to benefit from this new method of optimizing availability, even when the maintenance is always provided by said operator.

The objects given to the invention are achieved with the help of a method of optimizing the operational availability of at least one aircraft or of a fleet of aircraft as a function of constraints associated with maintenance and with the use of said aircraft, the method consisting in:
using a forecast maintenance plan for the aircraft;
adapting the forecast maintenance plan in real time as a function of maintenance operations carried out and/or as a function of unexpected maintenance operations that result from malfunctions diagnosed in one or more of the pieces of equipment of the aircraft; and
adapting the forecast maintenance plan continuously as a function of the actual use of the aircraft so as to provide the manufacturer, the operator, and the maintenance services with a maintenance plan that is forecast and dynamic.

By way of example, the method in accordance with the invention is implemented by means of an optimization algorithm consisting in:
adapting the dates of overhauls for major maintenance operations that are periodic and aperiodic as defined in the initial maintenance plan of the manufacturer, as a function of real conditions of use;
taking account of the degree of importance of the maintenance operations defined in the initial maintenance plan; and
taking account of the resources and the competences of the maintenance personnel available on maintenance sites in order to calculate availability values.

In an implementation, by virtue of an optimization algorithm, the method in accordance with the invention, consists in:
optimizing the management of missions to be performed by aircraft in a fleet by determining the different types of mission that are to be performed by the different models of aircraft; and
establishing an operating scenario showing the periods of use, the different types of mission, and the aircraft models used for performing said missions in such a manner as to calculate availability values.

In order to determine the main sources of aircraft unavailability, in the method in accordance with the invention, availability modeling consists, for example, in:
acquiring data from the operator such as flying times, flight rates, or environmental constraints;
acquiring data from the manufacturer of the aircraft such as lists of equipment, technical constraints, environmental constraints, or constraints associated with maintenance activities;
processing the data to determine operating times for each aircraft and to determine an estimate of an availability rate for the aircraft; and
comparing the availability rate with reference models in the market segment in which the aircraft are operated.

In the context of the method in accordance with the invention, in order to identify elements for improving in order to increase aircraft availability, availability modeling consists, for example, in:
using recorded data about the operation of the aircraft;
constructing a real availability tree of the aircraft, said tree being based on operational and non-operational times, in order to deduce the probability of a request for an intervention in the following time period and consequently to deduce a possibility of performing a maintenance operation during said period; and
interpreting the results of the availability modeling in order to determine the availability values that can be expected.

By way of example, the method in accordance with the invention is implemented by means of an optimization algorithm consisting in:
drawing up a list of equipment subsets or of portions of the aircraft; and
studying the subsets so as to reduce the non-availability induced by each subset when calculating availability values.

The objects given to the present invention are also achieved with the help of a system for operating a fleet of aircraft such as helicopters, to implement the above-mentioned optimization method and comprising a central unit serving to analyze firstly the initial recorded data and secondly the acquired data coming from the use and the maintenance of the aircraft, communications means connecting the central unit to the aircraft, to the operator, to the maintenance services, and to the manager of stocks of spare parts, and means for issuing a modified forecast maintenance plan.

The objects given to the present invention are also achieved with the help of an aircraft, such as a helicopter, associated with such an operating system.

The method in accordance with the invention presents the advantage of enabling the manufacturer to propose a recommended maintenance program to each client adapted to the client's operating scenario.

Another advantage for the manufacturer lies in the possibility of making an undertaking to clients that a given availability threshold will be achieved in the operation of the aircraft.

Another advantage obtained by the method in accordance with the invention lies in a reduction in costs associated with aircraft unavailability. This reduction results from the turn-over generated by operating aircraft and also from optimizing stocks of spare parts, increasing the reactivity with which the fleet of aircraft is managed, and optimizing the use and the maintenance of the fleet of aircraft.

The method in accordance with the invention presents the advantage of taking account of data from algorithms for diagnosing and locating breakdowns.

### BRIEF DESCRIPTION OF THE DRAWING

The invention and its advantages appear in greater detail from the following description of an embodiment given by way of illustration with reference to the accompanying sole FIGURE, which is a diagram of an operating system implementing various steps of the optimization method in accordance with the invention.

### DETAILED DESCRIPTION

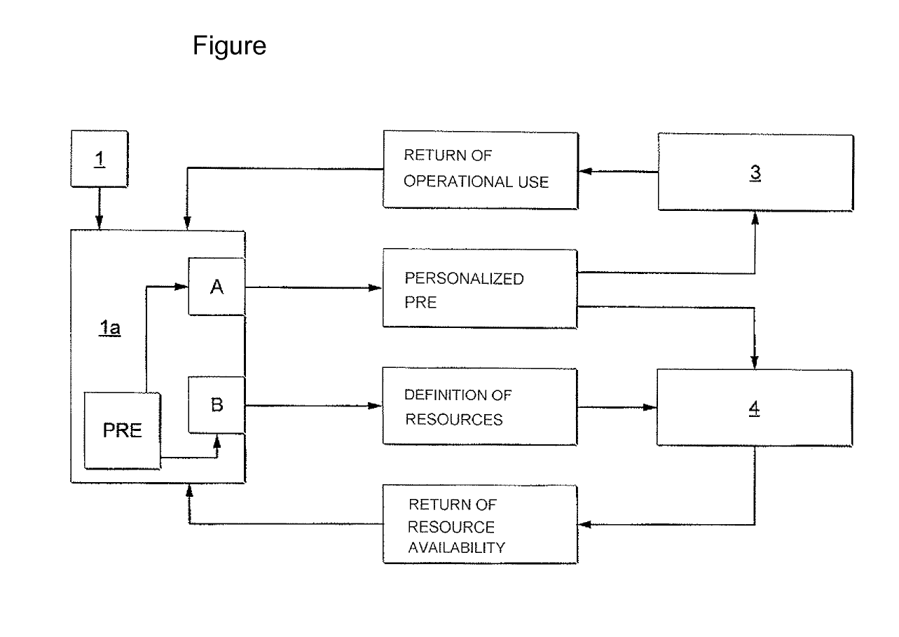

The operating system in accordance with the invention and shown in part in FIG. 1 has maintenance infrastructure including a manufacturer 1 of aircraft 2, the operator 3 of the aircraft 2, maintenance services 4, and stocks 5 of spare parts.

The manufacturer 1 uses a central unit 1a to analyze, process, and record initial data and data that is acquired during the use and the maintenance of the aircraft 2.

The operating system also includes communications means of wired or other type for establishing communication between the central unit 1a, the or each aircraft 2, the operator 3, the maintenance services 4, and the stock 5 of spare parts.

The central unit 1a is thus in a position to issue a recommended maintenance program adapted to the history of the usage of the aircraft 2. This forecast recommended maintenance program thus presents a dynamic character. The recommended maintenance program is personalized to be adapted individually to each aircraft in a fleet, in which operation differs from one aircraft to another.

Thus, by using the initial recommended maintenance program PRE, also referred to as the forecast maintenance plan, the central unit 1a thus makes it possible, to adapt the initial recommended maintenance program PRE on the basis of information returned thereto and relating firstly to the operational usage of the aircraft and secondly to the availability of maintenance resources. The central unit 1a then makes forecasts in terms of operating needs A and forecasts in terms of maintenance resource availability B. Maintenance resources include personnel, spare parts, maintenance infrastructure, and the pieces of equipment used.

Forecasts in terms of operating needs then make it possible to draw up a personalized recommended maintenance program for the aircraft 2 that can be communicated to the operator 3 and the maintenance services 4.

Forecasts concerning availability of maintenance resources are used to define the resources needed to maintain the aircraft. Information relating to said necessary maintenance resources is transmitted to the maintenance services 4 that are to carry out the maintenance of the aircraft 2.

Naturally, the present invention can be subjected to numerous variations as to its implementation. Although several embodiments and implementations are described above, it will readily be understood that it is not conceivable to identify exhaustively all possible embodiments and implementations. It is naturally possible to envisage replacing any of the means or steps described with equivalent means or an equivalent step without going beyond the ambit of the present invention.

What is claimed is:

1. A method of optimizing the operational availability of at least one aircraft or of a fleet of aircraft as a function of constraints associated with maintenance and with the use of said aircraft, the method consisting in:
using a forecast maintenance plan for the aircraft;
adapting the forecast maintenance plan in real time as a function of maintenance operations carried out and/or as a function of unexpected maintenance operations that result from malfunctions diagnosed in one or more of the pieces of equipment of the aircraft; and
adapting the forecast maintenance plan continuously as a function of the actual use of the aircraft so as to provide the manufacturer, the operator, and the maintenance services with a maintenance plan that is forecast and dynamic.

2. A method according to claim 1, that is implemented using an optimization algorithm consisting in:
adapting the dates of overhauls for major maintenance operations that are periodic and aperiodic as defined in the initial maintenance plan of the manufacturer, as a function of real conditions of use;
taking account of the degree of importance of the maintenance operations defined in the initial maintenance plan; and
taking account of the resources and the competences of the maintenance personnel available on maintenance sites in order to calculate availability values.

3. A method according to claim 1, that is implemented by an optimization algorithm consisting in:
optimizing the management of missions to be performed by aircraft in a fleet by determining the different types of mission that are to be performed by the different models of aircraft; and
establishing an operating scenario showing the periods of use, the different types of mission, and the aircraft models used for performing said missions in such a manner as to calculate availability values.

4. A method according to claim 2, that is implemented by an optimization algorithm consisting in:
optimizing the management of missions to be performed by aircraft in a fleet by determining the different types of mission that are to be performed by the different models of aircraft; and
establishing an operating scenario showing the periods of use, the different types of mission, and the aircraft models used for performing said missions in such a manner as to calculate availability values.

5. A method according to claim 3, wherein in order to determine the main sources of characterized unavailability, availability modeling consists in:
acquiring data from the operator such as flying times, flight rates, or environmental constraints;
acquiring data from the manufacturer of the aircraft such as lists of equipment, technical constraints, environmental constraints, or constraints associated with maintenance activities;
processing the data to determine operating times for each aircraft and to determine an estimate of an availability rate for the aircraft; and
comparing the availability rate with reference models in the market segment in which the aircraft are operated.

6. A method according to claim 3, wherein in order to identify elements that need improving in order to increase the availability of the aircraft, the availability modeling consists in:
using recorded data about the operation of the aircraft;
constructing a real availability tree of the aircraft, said tree being based on operational and non-operational times, in order to deduce the probability of a request for an intervention in the following time period and consequently to deduce a possibility of performing a maintenance operation during said period; and
interpreting the results of the availability modeling in order to determine the availability values that can be expected.

7. A method according to claim 4, wherein in order to identify elements that need improving in order to increase the availability of the aircraft, the availability modeling consists in:
using recorded data about the operation of the aircraft;
constructing a real availability tree of the aircraft, said tree being based on operational and non-operational times, in order to deduce the probability of a request for an intervention in the following time period and consequently to deduce a possibility of performing a maintenance operation during said period; and
interpreting the results of the availability modeling in order to determine the availability values that can be expected.

8. A method according to claim 1, that is implemented by an optimization algorithm consisting in:
drawing up a list of equipment subsets or of portions of the aircraft; and
studying the subsets so as to reduce the non-availability induced by each subset when calculating availability values.

9. A system for operating a fleet of aircraft such as helicopters, for implementing the optimization method in accordance with claim 1, wherein the system comprises a central unit serving to analyze firstly the initial recorded data and secondly the acquired data coming from the use and the maintenance of the aircraft, communications means connecting the central unit to the aircraft, to the operator, to the maintenance services, and to the manager of stocks of spare parts, and means for issuing a modified forecast maintenance plan.

10. An aircraft such as a helicopter, associated with an operating system in accordance with claim 9.
